(19) United States
(12) Patent Application Publication
(10) Pub. No.: US 2007/0176107 A1
(43) Pub. Date: Aug. 2, 2007

(54) OPTICAL ENGINE WITH A REPLACEABLE LIGHT TUNNEL

(75) Inventors: Shengwei Lin, Taoyuan County (TW); Mao Shan Hsu, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/557,361

(22) Filed: Nov. 7, 2006

(30) Foreign Application Priority Data
Jan. 27, 2006 (TW) 095103758

(51) Int. Cl. G01T 1/24

(52) U.S. Cl. 250/370.08

(57) ABSTRACT

An optical engine for use in a projection apparatus is disclosed, wherein the optical engine carries an illumination system and an imaging system for co-defining an optical axis, while a light beam emitted from the illumination system is transmitted to the imaging system along the optical axis. The optical engine comprises a chassis, a housing, a light tunnel apparatus and a holding edge. The dimensions of the receiving space defined by the holding edge and the housing are substantially constant and identical to the dimensions of the light tunnel apparatus comprised of a light tunnel and a bracket apparatus. The receiving space comprises a symmetry centerline coinciding with the optical axis to prevent the light beam from deviating away from the optical axis. To accommodate different resolutions, the differently sized light tunnels may fit into the receiving space, provided that the bracket apparatus comes in a size that can maintain constant dimensions after assembly with the light tunnel.

This application benefits from the priority of Taiwan Patent Application No. 095103758 filed on Jan. 27, 2006.

### CROSS-REFERENCES TO RELATED APPLICATIONS

Not applicable.

### BACKGROUND OF THE INVENTION

1. Field of the Invention

The present invention relates to an optical engine. In particular, the present invention relates to an optical engine with a replaceable light tunnel that can be easily replaced to match different needs.

2. Descriptions of the Related Art

The basic purpose of a conventional digital light processing™ (DLP™) projection apparatus is to convert a digital video signal into a series of digital light pulses. These digital light pulses are detected by human eyes and decoded as analog color images. The primary technology used by the DLP™ is the digital micromirror device (DMD), which converts digital electronic signals into optical signals.

In comparison with analog technology used in liquid crystal displays (LCD), the digital signal image processing of a DLP™ projection apparatus is not affected by the environment, such as climate fluctuations in terms of temperature or humidity. Because the reflecting surface edge of the DMD of a DLP™ is longer than the distance between the DMDs during image viewing, the fill factor of the DLP™ projection apparatus is high; that is, most of the DMDs indeed reflect to generate the image. As a result, the image appears more natural. Compared with the mechanism of DLP™, the LCD pixels are too small, resulting in grainy and unreal images. Furthermore, the DMD completes the ON and the OFF operations with high speed. An image that is generated quickly and clearly by the DLP™ is much better than an image generated by the LCD.

FIG. 1 shows a schematic view of an optical system of a DLP™ projection apparatus. After passing through a color wheel 103 and a light tunnel 105, the light beam, generated by a light source 101, is transmitted for image processing by a prism assembly 109 and the DMD device (not shown) in the chassis 107. The image is then directly projected by a projection lens assembly 111 or projected onto a display screen after reflecting off of a reflector. Together, the light source 101, color wheel 103, and light tunnel 105 are generally known as an illumination system 113 of an optical system, while the prism assembly 109, DMD device, and projection lens assembly 111 are generally known as an imaging system 115. The illumination system 113 and the imaging system 115 co-define an optical axis. The illumination system 113 emits the light beam that is transmitted to the imaging system 115 along the optical axis.

To meet the resolution and size requirements (e.g. 0.9″, 0.7″ or 0.55″) of a DMD panel in a DLP™ projection apparatus, different types of chassis are needed for fixing different sized light tunnels on the corresponding chassis. Different sizes of chassis are also provided for alignment of the original optical axis and to ensure an inherent path along which the light can travel under different light tunnel sizes. Unfortunately, different sizes of chassis result in high cost for manufacturing and fabricating the DLP™ projection apparatus for different sized panels. To accommodate different resolutions by interchanging different sized light tunnels in a common optical engine, a technique that (1) allows easy replacement of the light tunnel, (2) reduces cost of designing different chassis, (3) reduces cost of manufacturing, and (4) does not affect the brightness and quality of the image, is needed for this industrial field.

### SUMMARY OF THE INVENTION

The primary object of this invention is to provide an optical engine for use in a projection apparatus. Because a chassis fits into a specifically sized space, the common optical engine can fit with the light tunnels, despite the size, without further design alterations.

However, in order to achieve the aforementioned objective, an optical engine with a replaceable light tunnel for use in a projection apparatus is described here. The optical engine carries an illumination system and an imaging system, wherein the illumination system and the imaging system co-define an optical axis. The illumination system emits the light beam that is transmitted to the imaging system along the optical axis. The optical engine comprises a chassis, a housing and, at least, one edge wall. The edge wall is configured to hold the light tunnel apparatus. The housing is adapted to detachably fix onto the chassis. The edge wall and the housing define the receiving space, which has a symmetric centerline that substantially coincides with the optical axis.

Another object of this invention is to provide an aforesaid light tunnel apparatus for the optical engine. By providing outer dimensions of the light tunnel apparatus, the size of the light tunnels in the light tunnel apparatus can be replaced without changing the inherent chassis of the optical engine. The light tunnel apparatus comprises a light tunnel and a bracket apparatus. The bracket apparatus is adapted to removably enclose the outer portion of the light tunnel to form the first profile. The receiving space defines the second profile, with the first profile substantially matching the dimensions of the second profile. Both the first and second profiles, along with the centerlines of the receiving space, substantially coincide with the optical axis to prevent the imaging axis from being shifted.

Yet a further object of this invention is to provide an aforesaid light tunnel apparatus set for the optical engine. The light tunnel apparatus set comprises a plurality of light tunnel apparatuses which substantially has the same first profile. Each light tunnel apparatus has a light tunnel and a bracket apparatus. The bracket apparatus is adapted to enclose an outer portion of the light tunnel to form the first profile. The receiving space defines the second profile, with the first profile substantially matching the dimensions of the second profile. To accommodate different resolutions, one of the many light tunnel apparatuses of the light tunnel apparatus set is used and easily assembled onto the common optical engine. The cost for manufacturing the optical engine is therefore reduced, unaffecting the brightness and quality of the image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view showing the optical engine of a digital light processing projection apparatus;

FIG. 2a is a schematic perspective view showing the optical engine with a replaceable light tunnel;

FIG. 2b is an enlarged view showing the portion where the replaceable light tunnel of FIG. 2a is provided;

FIG. 3a is a perspective view showing the light tunnel apparatus; and

FIG. 3b is a perspective exploded view showing the light tunnel apparatus of FIG. 3a.

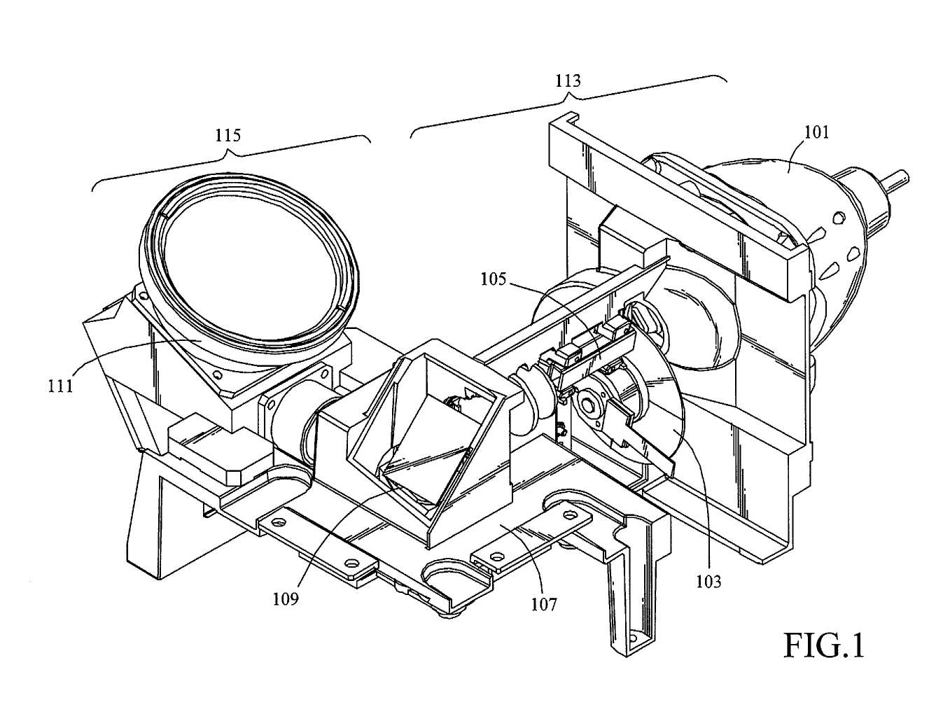

### DESCRIPTION OF THE PREFERRED EMBODIMENT

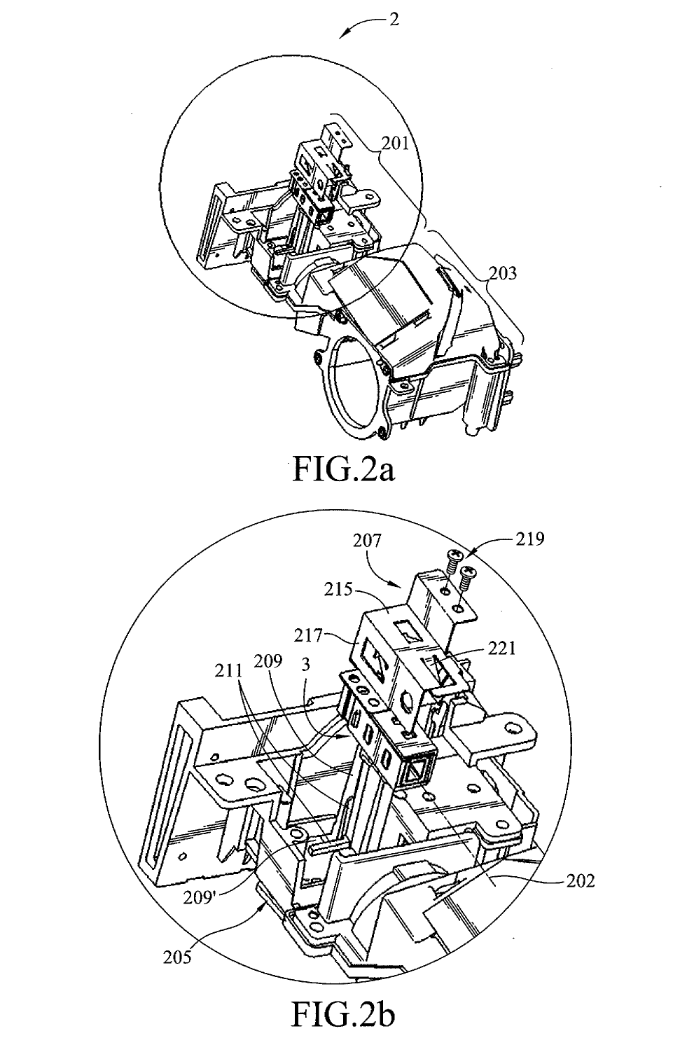

A preferred embodiment of this invention that shows an optical engine with a replaceable light tunnel is shown in FIG. 2a and FIG. 2b. The optical engine 2 is used in a projection apparatus for carrying an illumination system 201 and an imaging system 203. The illumination system 201 and the imaging system 203 co-define an optical axis. The illumination system 201 emits a light beam that is transmitted to the imaging system 203 along the optical axis. After being processed as an image by the imaging system 203, the image is projected onto a display screen.

The optical engine 2 comprises a chassis 205 and a housing 207. The chassis 205 comprises at least one edge wall 209 for holding a light tunnel apparatus 3. The housing 207 is adapted to be detachably fixed on the chassis 205. The edge wall 209 and the housing 207 define a receiving space, which has a symmetric centerline 202 that substantially coincides with the optical axis.

Preferably, the chassis 205 comprises two edge walls 209, 209′ that are substantially perpendicular to each other. The aforementioned housing 207 comprises a top frame 215, a side frame 217, and a fastening device. The fastening device can be a screw 219. The side frame 217 is substantially perpendicular to the top frame 215, while the screw 219 detachably fixes the top frame 215 and the side frame 217 onto the chassis 205. Each or both of the edge walls 209, 209′ further comprise a reference device, preferably, a rib 211. The receiving space is mainly defined by the rib 211 and the housing 207, and enables the symmetric centerline 202 to substantially coincide with the optical axis.

Furthermore, the aforementioned housing 207 further comprises an elastic pushing device 211, disposed on either the top frame 215 or the side frame 217, whereby the light tunnel apparatus 3 in the chassis can be inwardly pushed to fix the light tunnel apparatus 3 onto the housing. The elastic pushing device 221 is preferably a leaf spring, a coil spring, or any equivalent that is able to implement an analogous function.

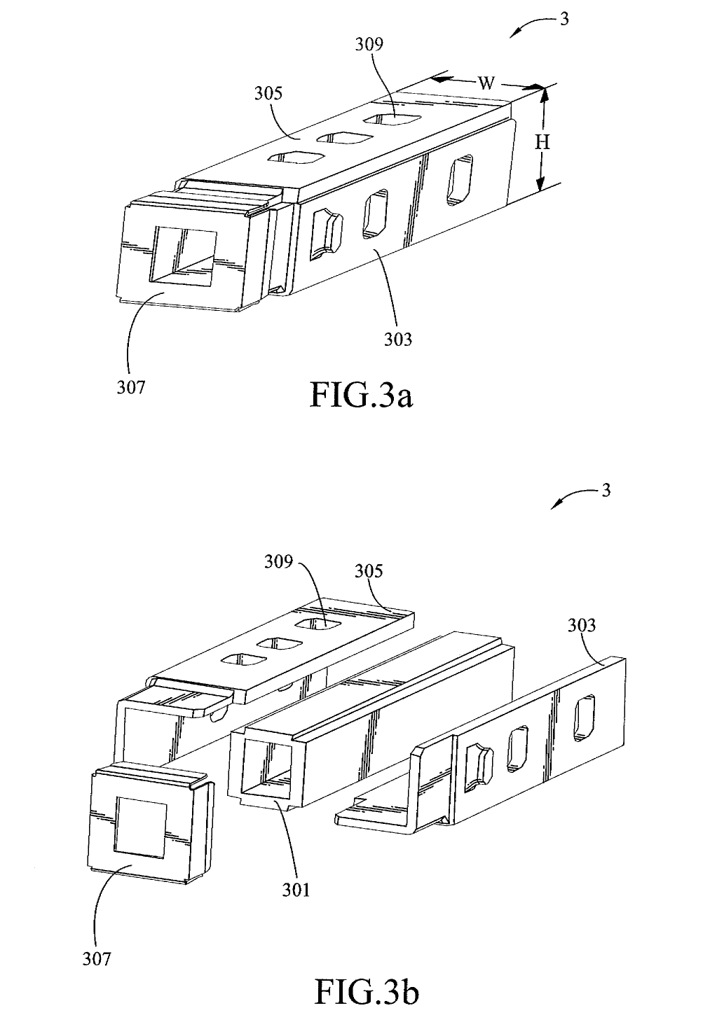

As shown in FIG. 3a and FIG. 3b, the light tunnel apparatus 3 is received by the optical engine 2 as illustrated in the first embodiment. FIG. 3a is a perspective view showing the light tunnel apparatus 3, while FIG. 3b is an exploded perspective view showing the light tunnel apparatus of FIG. 3a. The light tunnel apparatus 3 comprises a light tunnel 301; and a bracket apparatus that is adapted to removably enclose an outer portion of the light tunnel 301 to protect, support and position the light tunnel, whereby forming a first profile. The first profile is configured by a width W and a height H as shown in FIG. 3a. The receiving space defines the second profile, with the first profile substantially matching the dimensions of the second profile.

More preferably, the bracket apparatus further comprises a plurality of injection holes 309. After the bracket apparatus encloses the light tunnel 301, glue is applied through the holes 309 to fix the relative position of the bracket apparatus and the light tunnel 301. In this embodiment, the plurality of injection holes 309 is evenly formed on the bracket apparatus to ensure that the glued positions are evenly distributed. The bracket apparatus further comprises two symmetric L shaped brackets 303, 305 adapted to substantially enclose the light tunnel 301 after assembly. It is understandable that the number and the shape of the aforementioned plurality of injection holes 309 are not limited by the aforementioned measures.

The shape and the assembly of the bracket apparatuses should not be limited either. For example, the bracket apparatus comprises two sheet irons, which are perpendicular to each other, and defines a space which does not completely enclose the light tunnel. Any modification or combination of the bracket apparatuses is feasible, as long as the light tunnel apparatus, after accommodating the light tunnel inside, constitutes a constant first profile that substantially matches the dimensions of the second profile defined by the receiving space.

Furthermore, the bracket apparatus comprises a plurality of fixing screws (not shown) for adjusting the light tunnel in the bracket apparatus. These screws are adapted to indirectly adjust the orientation (e.g. angles and positions) of the generally parallel light beams emitted from the light tunnel into the optical engine. This embodiment preferably requires at least two fixing screws, substantially disposed perpendicular to each other for adjusting the two relative dimensional positions between the light tunnel and the bracket apparatus.

In the aforementioned embodiment, the chassis 205, the housing 207, and the bracket apparatus are made of a material that can efficiently assist in heat dissipation and prevent the glue in the light tunnel 301 from softening, denaturalizing, or melting because of heat accumulation. The material can be iron, copper, lead or any combination thereof. The aforementioned light tunnel apparatus further comprises a front baffle 307 that assists in both guiding the light beam generated by the light source into the light tunnel 301, as well as aligning the incident light beam with the correct travel path without allowing the light to erroneously hit the end edges of the light tunnel 301.

Using the example of a digital micromirror device that is 0.7 inches by 0.5 inches, the corresponding apertures of the light tunnel would be 6.15×4.8 mm and 4.8×3.8 mm, respectively. The thickness of the bracket apparatus enclosing the light tunnel would be 0.6 mm. The first profiles defined by the bracket apparatus of the two light tunnels would be as follows: the width W of the former is 0.6×2+6.15=7.35 mm; the height H of the former is 0.6×2+4.8=6.0 mm; the width W of the latter is 6.0 mm; the height H of the latter is 5.0 mm. To save costs by using common optical elements, the different light tunnel positioning systems should be designed to ensure that the optical axes of the light tunnel and the optical axis of the illumination system (as well as the imaging system) substantially coincide with each other. The present invention changes some features of the common light tunnel. Specifically, the light tunnel with the 6.15×4.8 mm aperture is coupled with the bracket apparatus that has a thickness of 0.6×0.6 mm. Likewise, the light tunnel with the 4.8×3.8 mm aperture is coupled with the bracket apparatus that has a thickness of 1.275×1.1 mm. The first profiles defined by the bracket apparatus of the two light tunnels are kept constant. Specifically, the width W of the former is 0.6×2+6.15=7.35 mm; the height H of the former is 0.6×2+4.8=6.0 mm; the width W of the latter is 1.275×2+4.8=7.35 mm; the height H of the later is 1.1×2+3.8=6.0 mm. By changing the profile of the bracket apparatus in the light tunnel, the surface profile would not be changed when the bracket apparatus encloses the differently sized light tunnels. The optical axes of the light tunnels in this case are kept on the same line.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical engine for use in a projection apparatus, the optical engine carrying an illumination system and an imaging system, wherein the illumination system and the imaging system co-define an optical axis, and the illumination system emits a light beam transmitting to the imaging system along the optical axis, the optical engine comprising:
a chassis, comprising at least one edge wall, for holding a light tunnel apparatus; and
a housing being adapted to be detachably fixed on the chassis;
wherein the at least one edge wall and the housing define a receiving space, which has a symmetric centerline, in which the symmetry centerline substantially coincides with the optical axis.

2. The optical engine as claimed in claim 1, wherein the chassis comprises two edge walls being substantially perpendicular to each other.

3. The optical engine as claimed in claim 2, wherein the housing comprises:
a top frame;
a side frame substantially perpendicular to the top frame; and
a fastening device for detachably fixing the top frame and the side frame on the chassis.

4. The optical engine as claimed in claim 3, wherein the housing further comprises an elastic pushing device, disposed on at least one of the top frame and the side frame, whereby inward pushing the light tunnel apparatus received in the chassis.

5. The optical engine as claimed in claim 1, wherein the at least one edge wall further comprises a reference device, whereby the receiving space defined by the reference device and the housing enables the symmetric centerline of the light tunnel apparatus received in the space to substantially coincide with the optical axis.

6. A light tunnel apparatus received in the optical engine as claimed in claim 1, comprising:
a light tunnel;
a bracket apparatus being adapted to removably enclose an outer portion of the light tunnel to form a first profile;
wherein the receiving space defines a second profile; and
the first profile substantially matches in dimension the second profile.

7. A light tunnel apparatus set for being received in the optical engine as claimed in claim 1, comprising:
a plurality of light tunnel apparatus each having:
a light tunnel;
a bracket apparatus being adapted to enclose an outer portion of the light tunnel to form the first profile;
wherein the receiving space defines a second profile; and
the first profile substantially matches in dimension the second profile.
